(19) United States
(12) Patent Application Publication
(10) Pub. No.: US 2024/0328924 A1
(43) Pub. Date: Oct. 3, 2024

(54) DEVICE, SYSTEM AND METHOD FOR TESTING CORROSION PROTECTION SYSTEMS

(71) Applicant: COPSYS TECHNOLOGIES INC., Logy Bay (CA)

(72) Inventor: Farzad Hashemi, Halifax (CA)

(21) Appl. No.: 18/698,886

(22) PCT Filed: Sep. 7, 2023
(86) PCT No.: PCT/IB2023/058867

§ 371 Date: Apr. 5, 2024

Related U.S. Application Data
(60) Provisional application No. 63/404,323, filed on Sep. 7, 2022.

(51) Int. Cl. G01N 17/02; C23F 13/04

(52) U.S. Cl. CPC G01N 17/02; C23F 13/04

(57) ABSTRACT

An example device for a corrosion protection system including a covering anode electrically insulated from a substrate to be protected includes: a housing having an end configured to be positioned over a portion of the covering anode of the corrosion protection system; a substrate simulator configured to simulate the substrate to be protected, the substrate simulator supported in the housing proximate the end; and at least one delivery channel configured to deliver an electrolyte to the end between the substrate simulator and the covering anode to test detection of a current flowing through the corrosion protection system to the substrate simulator via the electrolyte.

### CROSS REFERENCE TO RELATED APPLICATIONS

The application claims priority to U.S. Application No. 63/404,323, filed Sep. 7, 2022, entitled “DEVICE AND METHOD FOR NON-DESTRUCTIVE TESTING OF A CORROSION PROTECTION SYSTEM”, the contents of which are incorporated herein by reference.

### FIELD

The specification relates generally to corrosion protection systems, and more particularly to a device, system, and method for testing a corrosion protection system.

### BACKGROUND

Cathodic Protection (CP) systems protect mostly steel structures such as ships, pipes, and the like, from corrosion by providing electrons to the substrate through sacrificial anodes (SACP), or permanent anodes and electron provider devices, Impressed Current Cathodic Protection (ICCP).

### SUMMARY

According to an aspect of the present specification an example testing device for a corrosion protection system including a covering anode electrically insulated from a substrate to be protected is described. The example testing device includes: a housing having an end configured to be positioned over a portion of the covering anode of the corrosion protection system; a substrate simulator configured to simulate the substrate to be protected, the substrate simulator supported in the housing proximate the end; and at least one delivery channel configured to deliver an electrolyte to the end between the substrate simulator and the covering anode to test detection of a current flowing through the corrosion protection system to the substrate simulator via the electrolyte.

According to another aspect of the present specification, an example method in a testing system to test a corrosion protection system includes: placing a substrate simulator proximate to and spaced apart from a covering anode of the corrosion protection system, the substrate simulator configured to simulate a substrate to be protected by the corrosion protection system; providing electrons to the testing system; administering an electrolyte between the substrate simulator and the covering anode; and detecting a response indicating a flow of the current between the substrate simulator and the covering anode via the electrolyte.

### BRIEF DESCRIPTION OF DRAWINGS

Implementations are described with reference to the following figures, in which:

FIG. 1 depicts an example testing system for testing a corrosion protection system.

FIG. 2 depicts an example testing device for testing a corrosion protection system.

FIG. 3 depicts a bottom view of the testing device of FIG. 2.

FIG. 4A depicts the testing device of FIG. 2 with an example clamp.

FIG. 4B depicts the testing device of FIG. 2 with another example clamp.

FIG. 5 depicts another example testing device for testing a corrosion protection system.

FIG. 6 depicts a flowchart of an example method of testing a corrosion protection system.

### DETAILED DESCRIPTION

Some corrosion protection systems, in addition to simply protecting the substrate, may additionally include sensors embedded in the system to detect defects in the corrosion protection system to allow prompt repair, thereby extending the lifetime and effectiveness of the corrosion protection system. It is therefore important to ensure such sensors and defect detection capabilities are functional. Some methods of testing the corrosion protection system include scribing (i.e., damaging or intentionally creating a defect in) the protective coatings of the corrosion protection system to test the corrosion protection system and defect detection capabilities. However, this evidently creates a defect in the corrosion protection system, which is counterproductive to its protective functionality.

Accordingly, as described herein, a testing system, device, and method allow for non-destructive testing of a corrosion protection system by simulating the substrate to be protected, and in particular, simulating exposure of the substrate to an electrolyte due to a scratch or other defect developing in the corrosion protection system, and the effect of a defect between the substrate to be protected and a covering anode of the corrosion protection system. In particular, the simulation occurs externally to the corrosion protection system, and hence can occur without damaging the corrosion protective system. That is, the simulation includes the covering anode, and is located at an exposed side of the covering anode (i.e., the side opposite the substrate to be protected).

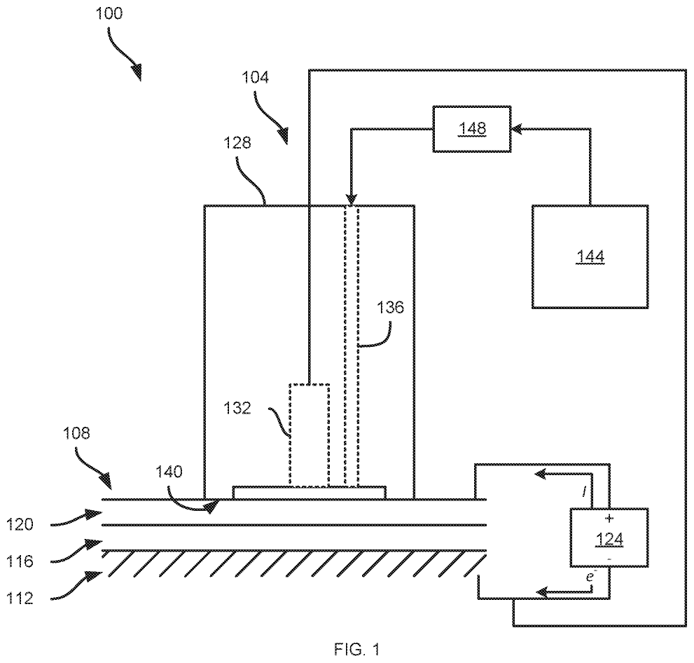

FIG. 1 depicts a testing system 100 including a testing device 104 for non-destructive testing of a corrosion protection system 108 in accordance with the present disclosure. Specifically, the system 100 allows for non-destructive testing of the corrosion detection and location functionality of the corrosion protection system 108 by simulating the substrate to be protected as well as damage to the electrically insulating layer of the corrosion protection system 108.

In particular, the corrosion protection system 108 is an impressed current cathodic protection (ICCP) system configured to protect a substrate 112, such as a metallic or steel object prone to corrosion. For example, the substrate 112 may be a pipe configured for fluid transfer, the body of a vehicle, such as a ship or car, or the like. The substrate 112 to be protected is covered by a series of coatings, including an electrically insulating layer 116 which themselves serve to protect the substrate 112 from corrosion. However, damage to the electrically insulating layer 116 and other coatings over time may allow defects to form, thereby exposing the substrate 112. Accordingly, the corrosion protection system 108 further includes a covering anode 120 and an electron source 124 which is connected at a negative terminal to the substrate 112 and at a positive terminal to the covering anode 120. Thus, the electron source 124 is configured to provide electrons to the substrate 112 to be protected via impressed current cathodic protection of the substrate 112.

In particular, the electrically insulating layer 116 separates the substrate 112 and the covering anode 120 to prevent current from flowing through the corrosion protection system 108. When a defect develops in both the electrically insulating layer 116 (e.g., a crack or similar) and the covering anode 120 that allows an electrolyte to interconnect the covering anode 120 and the substrate 112, an electrochemical cell is formed and allows current to flow from the positive terminal of the electron source 124 to the covering anode 120, the electrolyte, and the substrate 112, and returning to the negative terminal of the electron source 124. That is, the flow of electrons from the electron source 124 to the substrate 112 protects the substrate 112 from corrosion.

Preferably, the corrosion protection system 108 may also include sensors embedded in the covering anode 120 to detect when an active current flows through the covering anode 120 to the substrate 112, thereby indicating a defect in the corrosion protection system 108 (see, e.g., PCT/IB2021/061321, the contents of which are incorporated herein by reference). Additionally, the sensors may be spaced apart in the covering anode 120, and respective strengths of signals (e.g., electrochemical current draw signals) detected by the sensors may allow the location of the defect to be identified.

To test the corrosion protection system 108, and particularly, that the sensors in the covering anode 120 detect the flow of current through the covering anode 120, a flow of current through the covering anode 120 is necessary. Accordingly, some methods of testing may scribe and/or otherwise damage the coatings, including the covering anode 120 and the electrically insulating layer 116 to create a defect through which an electrolyte may be passed to complete the electrochemical cell. However, such a destructive test is counterproductive to the protection of the substrate 112, since the coating, including the electrically insulating layer 116 and the covering anode 120 are defective after such tests.

Accordingly, the system 100 allows for non-destructive testing of the corrosion protection system 108. In particular, the testing device 104 includes a housing 128, a substrate simulator 132, and at least one delivery channel 136, which allow the device to simulate an electrochemical cell including the covering anode 120 without damaging the electrically insulating layer 116 or the covering anode 120. In particular, the device 104 simulates an electrochemical cell on a side of the covering anode 120 opposite the substrate 112.

The housing 128 is generally configured to house the components of the testing device 104 and may be made of a non-metallic, and particularly, a non-electrically conductive material, such as plastic or similar. That is, the housing 128 is formed of a material which will not contribute to or interfere with the simulation of the electrochemical cell with the covering anode 120.

The housing 128 defines an interior in which the substrate simulator 132 is supported. The substrate simulator 132 is configured to simulate the substrate 112 to be protected by the corrosion protection system 108, and hence may be formed of a metal or similarly electrically conductive material that simulates the same function as the substrate 112 in an electrochemical cell. Preferably, the substrate simulator 132 may be made of the same or similar material as the substrate 112 to be protected. In particular, the substrate simulator 132 simulates an area of the substrate 112 which is exposed due to a defect or other damage to the electrically insulating layer 116 and the covering anode 120.

In particular, the substrate simulator 132 is supported in the housing 128 proximate an end 140 of the housing 128. The end 140 is configured to be positioned over a portion of the covering anode 120 and may be open or partially open to expose the substrate simulator 132. In particular, when the housing 128 is positioned with the end 140 over the covering anode 120, the substrate simulator 132 is supported proximate and spaced away from the covering anode 120.

The delivery channel 136 is configured to deliver fluid, and more particularly, an electrolyte out the end 140 of the housing 128 between the substrate simulator 132 and the covering anode 120. For example, the testing device 104 may be in fluid communication with a reservoir 144 configured to contain a supply of the electrolyte. The testing system 100 may further include an actuator 148, such as a pump, configured to drive the electrolyte from the reservoir 144 to the testing device 104, and more particularly, to the delivery channel 136.

The electrolyte delivered between the substrate simulator 132 and the covering anode 120 therefore allows current to be conducted between the covering anode 120 and the substrate simulator 132 to allow an electrochemical cell to be formed. Preferably, the electrolyte may be similar in composition to electrolytes which would be present in the corrosive environment of the substrate 112 and the corrosion protection system 108. For example, if the corrosion protection system 108 is to be used for a substrate 112 immersed in seawater, then the electrolyte may preferably be seawater.

Accordingly, in operation, to test the corrosion protection system, the substrate simulator 132 may also be connected to the electron source 124 at the negative terminal, for example by a wire (not shown). In some examples, the wire may extend from the substrate simulator 132 directly to the negative terminal of the electron source 124 and hence the housing 128 may include a passage for the wire and an aperture to allow the wire to extend therethrough. In other examples, the substrate simulator 132 may be electrically connected to a device terminal (e.g., at an end of the housing 128 opposite the end 140) and the wire may extend between the device terminal and the negative terminal of the electron source 124. In some examples, an electron source separate from the electron source 124 may be used for testing purposes.

Thus, when the electrolytes delivered via the delivery channel 136 between the substrate simulator 132 and the covering anode 120, the electrochemical cell is completed, allowing current to flow from the covering anode 120 through the substrate simulator 132 and returning to the electron source 124. In some examples, a current measuring device (not shown) may be connected between the positive terminal of the electron source 124 and the covering anode 120 to measure the current draw by the covering anode 120. In other examples, the measure of the current draw by the covering anode 120 may occur internally to the electron source 124.

Since the electrochemical cell is complete, the current flowing through the covering anode 120 may be detected by sensors embedded in the covering anode 120. Accordingly, the response detected by the sensors may be analyzed to determine the performance of the corrosion protection system 108. For example, if the response indicates that current is detected, then the analysis may determine that the corrosion protection system 108 is correctly configured and capable of detecting current when it is transmitted through the covering anode 120. Furthermore, the relative strengths of the current signals detected at each of the sensors of the covering anode 120 may be analyzed to determine a location predicted by the corrosion protection system 108 and to verify that the determined location matches the location at which the testing device 104 was employed. If the response indicates that no current is detected, it may be determined that the corrosion protection system 108 is non-functional or mis-configured and further troubleshooting may be undertaken.

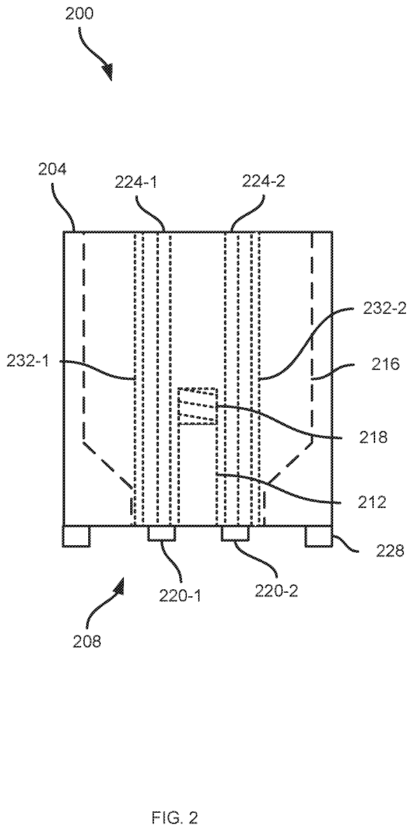

Turning now to FIG. 2, another example testing device 200 is depicted. The testing device 200 is similarly configured to non-destructively test a corrosion protection system, such as the system 108 by simulating an electrochemical cell at the covering anode 120 opposite the substrate 112.

The testing device 200 includes a housing 204, similar to the housing 128, formed of a non-electrically conductive material and configured to house the components of the testing device 200. In particular, the housing 204 includes an end 208 configured to be positioned over the covering anode 120 of the corrosion protection system 108.

The testing device 200 further includes a substrate simulator 212, similar to the substrate simulator 132, configured to simulate the substrate 112 to be protected. The substrate simulator 212 is supported in the housing 204 proximate the end 208. In particular, the substrate simulator 212 may be supported in a support body 216. The support body 216 may further include a mechanism 218 (e.g., a piston, a nut and bolt, a spring, or the like) to allow the substrate simulator 212 to extend from the support body 216 for distance adjustment, cleaning and the like. That is, the mechanism 218 may be actuated (e.g., via an aperture and passage in the support body 216 opposite the substrate simulator 212) to allow the substrate simulator 212 to extend away from and retract into the support body 216.

The support body 216 is configured to sit in the housing 204. For example, the support body 216 may be substantially complementary in shape to the interior of the housing 204 to allow the support body 216 to be located at a predefined location within the housing 204. Accordingly, the support body 216 may also be configured to situate and maintain the substrate simulator at a predefined location within the housing 204, and more particularly, at a predetermined location (i.e., at a predefined distance) relative to the end 208 of the housing 204.

Further, when the end 208 of the housing 204 is positioned over the covering anode 120, the substrate simulator 212 may be located at a predictable and consistent distance from the covering anode 120. Preferably, the substrate simulator 212 may be located at a distance from the covering anode 120 equivalent to a distance between the covering anode 120 and the substrate 112 to be protected.

To facilitate the spacing of the substrate simulator 212 away from the covering anode 120, the support body 216 may be configured to support the substrate simulator 212 substantially flush with the end 208 of the housing 204 and the housing 204 may include one or more spacers, of which two spacers 220-1 and 220-2 are depicted (referred to herein generically as a spacer 220 and collectively as the spacers 220; this nomenclature is also used elsewhere herein) at the end 208 of the housing 204. The spacers 220 may therefore be configured to space the end 208 (and therefore the substrate simulator 212) from the covering anode 120 by the distance between the covering anode 120 and the substrate 112 to be protected. That is, the length or thickness of the spacers 220 is equal to the distance between the covering anode 120 and the substrate 112 to be protected.

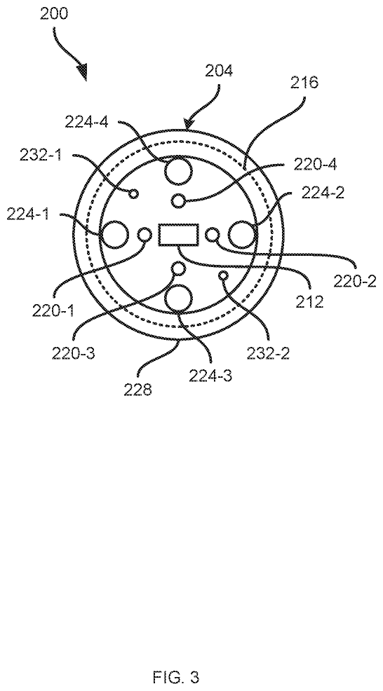

Preferably, the housing 204 may include at least three spacers 220 spaced substantially evenly about the substrate simulator 212 to evenly space the substrate simulator 212 from the covering anode 120. For example, referring to FIG. 3, a bottom view of the testing device 200 is depicted. As can be seen, the testing device 200 includes four spacers 220-1, 220-2, 220-3, and 220-4, spaced about the substrate simulator 212. In other examples, more or fewer spacers 220 may be included in the testing device 200 to optimize stability and consistency of the distance between the substrate simulator 212 and the covering anode 120. Preferably, the spacers 220 may be formed integrally with the housing 204. In some examples, the spacers 220 may be rings rather than pins, and may be made of varying thicknesses for different applications and coating thicknesses.

Returning to FIG. 2, the testing device 200 further includes at least one delivery channel, of which two delivery channels 224-1 and 224-2 are depicted. In particular, in the present example, the delivery channels 224 may extend through the support body 216. In other examples, the delivery channels 224 may extend through the housing 204 itself, around the support body 216. The delivery channels 224 are similar to the delivery channels 136 and are configured to deliver electrolyte out the end 208 between the substrate simulator 212 and the covering anode 120 when the testing device is positioned over the covering anode 120. The delivery channels 224 may be in fluid communication with the reservoir 144 and the actuator 148 to receive the electrolyte.

Preferably, the testing device 200 may include at least three delivery channels 224 to deliver the electrolyte between the substrate simulator 212 and the covering anode 120. For example, referring again to FIG. 3, the testing device 200 may include four delivery channels 224-1, 224-2, 224-3, and 224-4, spaced about the substrate simulator 212. In other examples, more or fewer delivery channels 224 may be included in the testing device 200, including in a combination of the support body 216 and the housing 204, to deliver of the electrolyte between the substrate simulator 212 and the covering anode 120.

Returning again to FIG. 2, the testing device 200 further includes a contact region 228 configured to contact the covering anode 120 when the testing device 200 is positioned over the covering anode 120. Preferably, the contact region 228 may extend from the end 208 of the housing 204. Further, the contact region 228 may preferably be formed of a deformable and resilient material to allow the contact region 228 to conform to the covering anode 120 and to allow the spacers 220 to contact the covering anode 120, for example if the covering anode 120 is not a completely flat surface. For example, the contact region 228 may be formed of rubbers, foams, plastics, combinations of the above, or other suitable materials. In some examples, the contact region 228 may include a structure (e.g., interconnected nodes or the like) which the contact region 228 to be resilient and deformable to conform to the covering anode and to allow the spacers 220 to contact the covering anode 120.

In some examples, the contact region 228 may extend around a perimeter of the end 208 of the housing 204 to form a border around a central region about the substrate simulator 212. Thus, when the electrolyte is delivered via the delivery channels 224, the contact region 228 may substantially bound the electrolyte in the central region between the substrate simulator 212 and the covering anode 120. The contact region 228 may therefore increases the likelihood that the electrolyte is maintained between the substrate simulator 212 and the covering anode 120 during testing, reducing the likelihood of a false test result.

Accordingly, as depicted in FIG. 2, the contact region 228 may extend past a length of the spacers 220 to allow for good contact between the contact region 228 and the covering anode 120, and to allow the contact region 228 to substantially conform to any irregularities in the covering anode 120. In such examples, the contact region 228 is formed of a material which is sufficiently compressible to be reduced to the length of the spacers 220, to allow the spacers 220 to additionally contact the covering anode 120 and space the substrate simulator 212 at the predetermined distance from the covering anode 120.

In some examples, to maintain the end 208 positioned over the covering anode 120 while compressing the contact region 228 to allow the spacers 220 to be in contact with the covering anode 120, the testing device 200 may be secured by a clamp to the corrosion protection system 108.

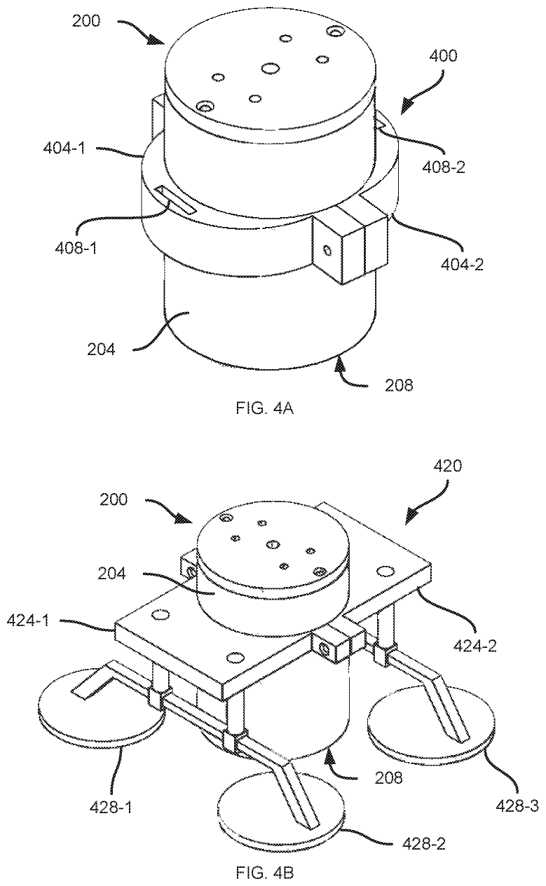

For example, referring to FIG. 4A, the testing device 200 with an example clamp 400 is depicted. In particular, the clamp 400 includes two segments 404-1 and 404-2 configured to be placed around the housing 204 of the testing device 200. In the present example, the two segments 404 are semi-annular to complement the shape of the housing 204 of the testing device 200. In other examples, the two segments 404 may have other shapes to similarly complement the shape of a testing device having different a different cross-section or shape.

In some examples, the segments 404 may include an internal layer formed of a material such as a rubber, a silicone, high density sponge, or the like, to allow the segments 404 to grip the testing device 200. In other examples, the housing 204 of the testing device 200 may include an indent or channel allowing the segments 404 to securely clamp the testing device 200 when secured around the housing 204.

The segments 404 are configured to be secured together, for example by a bolt or another suitable fastener. In some examples, the segments 404 may be joined at one end, for example, by a hinge or the like, allowing the segments 404 to be rotated relative to one another to receive and be secured around the testing device 200. The segments 404-1 and 404-2 each include respective slots 408-1 and 408-2 extending through the segments 404, substantially parallel to the testing device 200 when the testing device 200 is secured between the segments 404.

In particular, the slots 408 may be configured to receive a belt (not shown) which may be secured around a pipe, or other substantially tubular substrate (i.e., a substantially tubular substrate 112, having the corrosion protection system 108 installed thereon). That is, a first end of the belt may be fed through and secured to the slot 408-1. The belt may then be extended around the pipe, and a second end of the belt may be secured to the slot 408-2. An adjustment mechanism of the belt may be actuated to secure the testing device 200 securely to the pipe. In particular, tightening of the belt may allow the housing 204 to be pulled towards the pipe, compressing the contact region 228 until the spacers 220 contact the pipe (having the covering anode 120 thereon).

Use of such an adjustable belt may allow the clamp 400 to be used to clamp the testing device 200 to pipes or other substantially tubular substrates of varying diameters or cross-sectional dimensions.

Referring to FIG. 4B, the testing device 200 with another example clamp 420 is depicted. The clamp 420 similarly includes two segments 424-1 and 424-2 configured to be placed around the housing 204 of the testing device 200. The two segments 424 are configured at an inner surface to complement the shape of the housing 204 of the testing device 200, and hence in the present example are semi-annular. The inner surface may further include an internal layer configured to allow the segments 424 to grip the housing 204 of the testing device 200. In other examples, the two segments 424 may be configured to be received in an indent or channel at an exterior surface of the housing 204 to allow the clamp 420 to securely clamp the testing device 200.

The segments 424 are configured to be secured together, for example by a bolt or another suitable fastener. The segments 424 may similar be joined at one end, for example by a hinge, allowing the segments 424 to be rotated relative to one another to receive the testing device 200.

The segments 424 are substantially plate-like, and are configured to extend substantially perpendicularly to a length of the testing device 200. The clamp 420 further includes suction cups, of which three suction cups 428-1, 428-2, and 428-3 are visible. Preferably, the suction cups 428 may located substantially symmetrically about the testing device 200. The suction cups 428 are configured to be applied to a substantially flat substrate (i.e., a substantially flat substrate 112, having the corrosion protection system 108 installed thereon). That is, the suction action of the suction cups 428 on the substrate draws the testing device 200 to the substrate, compressing the contact region 228 until the spacers 220 contact the substrate (having the covering anode 120 thereon).

In other examples, other suitable clamps or means of securing the testing device 200 firmly to the covering anode 120 over a substrate 112, which may compress the contact region 228 until the spacers 220 contact the covering anode 120 are also contemplated.

Returning to FIG. 2, when the testing device 200 is securely clamped to the covering anode 120, the contact region 228 forms a border for the central region about the substrate simulator 212. When electrolyte is delivered to this central region via the delivery channels 224, the electrolyte is maintained within the central region by the contact region 228. Accordingly, a sufficient amount of the electrolyte may increase pressure in the central region and may push the testing device 200 away from the covering anode 120. Accordingly, the testing device 200 may further include one or more relief channels, of which two example relief channels 232-1 and 232-2 are depicted. The relief channels 232 are configured to receive backflow of excess electrolyte delivered to the space between the substrate simulator 212 and the covering anode 120. The relief channels 232 may extend through portions of one or more of the housing 204 and the support body 216. In the present example, the relief channels 232 extend out an end of the testing device 200 opposite the end 208; in other examples, the relief channels 232 may have other outlets.

As depicted, the testing devices 104 and 200 allow for non-destructive testing of the corrosion protection system 108 for the substrate 112 by allowing an electrochemical cell to be formed using the covering anode 120 on a side of the covering anode 120 opposite the substrate 112. As depicted in FIGS. 1 and 2, the reservoir 144 and the actuator 148 are separate from the testing devices 104 and 200; in other examples, one or both of the reservoir 144 and the actuator 148 may be integrated into the testing devices 104 and 200.

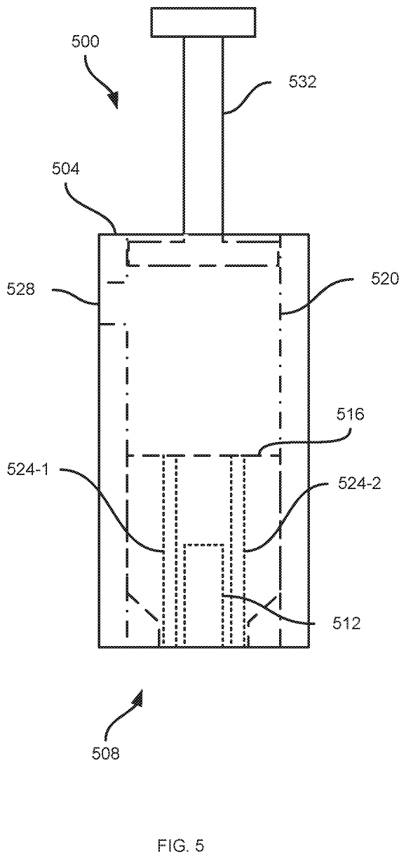

For example, referring to FIG. 5, another example testing device 500 is depicted. The testing device 500 includes a housing 504 having an end 508 configured to be positioned over the covering anode 120 of the corrosion protection system 108.

The testing device 500 further includes a substrate simulator 512 configured to simulate the substrate 112 to be protected. In particular, the substrate simulator 512 is supported in a support body 516 configured to sit in the housing 504. Further, the support body 516 may occupy only a portion of an interior passageway 520 of the housing 504, allowing space for the interior passageway 520 for delivery of the electrolyte. The testing device 500 further includes delivery channels 524-1 and 524-2 extending through the support body 516. In particular, the delivery channels 524 are in fluid communication with the passageway 520.

In operation, rather than pumping the electrolyte directly into the delivery channels 524, the electrolyte may be delivered at one or more injection sites 528 to the passageway 520. The testing device 500 may therefore further include an actuator 532, which in the present example is a plunger, configured to drive the electrolyte through the passageway 520, the delivery channels 524, and out the end 508.

In further examples, the testing device 500 may include further injection sites or other configurations. For example, the testing device 500 may include an arm (not shown) extending from the body, substantially perpendicular to the passageway 520. The arm may include a passageway and an injection site of its own, in fluid communication with the passageway 520. The arm may further include an actuator configured to drive fluid from the passageway of the arm into the passageway 520. The arm may allow for flexibility in applying the testing device on a horizontally or vertically oriented surface, so that the electrolyte may be more easily injected into the testing device 500 and driven from the testing device 500 to the space between the substrate simulator 512 and the covering anode 120.

The testing device 500 may allow for manual actuation of the actuator 532, for example to more precisely control the delivery of the electrolyte to the space between the substrate simulator 512 and the covering anode 120. Accordingly, in some examples, the testing device 500 may include a one-way or check valve or similar between the passageway 520 and the delivery channels 524 to control the flow of the electrolyte.

Preferably, the testing device 500 may also include one or more spacers (not shown) to space the end 508 of the testing device 500 away from the covering anode 120, preferably by a distance between the covering anode 120 and the substrate 112 to be protected. Similarly, the testing device 500 may include a contact region (not shown) to conform to the covering anode 120 while allowing the spacers to contact the covering anode 120.

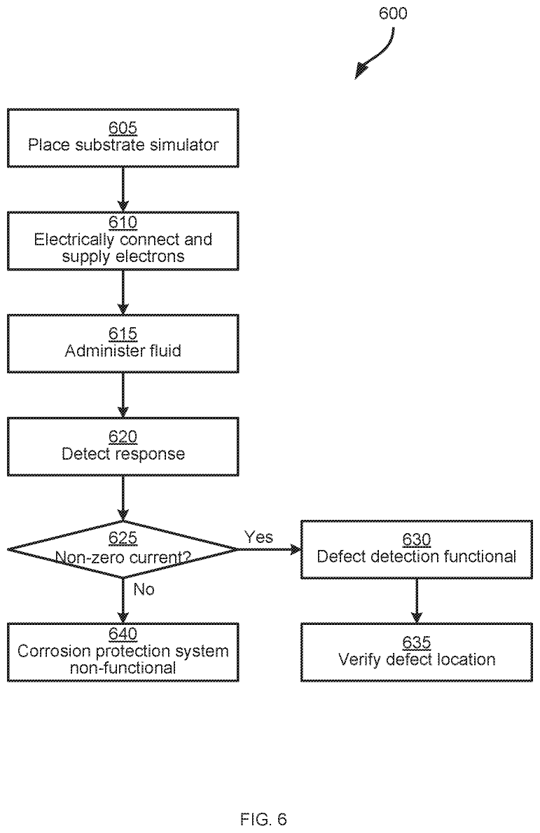

Turning now to FIG. 6, an example method 600 of testing a corrosion protection system is illustrated. The method 600 will be discussed in conjunction with its performance in the system 100, and particularly to test the corrosion protection system 108. For example, the method 600 may be performed using the testing devices 104, 200, 500. In other examples, the method 600 may be performed by other suitable devices and/or in other suitable systems.

At block 605, a substrate simulator (such as the substrate simulator 132, 212, or 512) is placed proximate to and spaced apart from the covering anode 120 of the corrosion protection system 108. In particular, the substrate simulator is configured to simulate the substrate 112 to be protected by the corrosion protection system 108, and may accordingly be formed of the same material or the like.

In some examples, placing the substrate simulator proximate to and spaced apart from the covering anode 120 may include positioning a testing device (i.e., such as the testing device 104, 200, or 500) over the covering anode 120. That is, the testing device may include the substrate simulator and may be configured to position the substrate simulator proximate to and spaced apart from the covering anode 120 when the testing device is positioned over the covering anode 120.

Preferably, the substrate simulator may be spaced apart from the covering anode by a predefined distance. In particular, the predefined distance may be equal to a distance between the covering anode 120 and the substrate 112 to be protected. For example, the testing device may include one or more spacers having a length or thickness equal to the distance between the covering anode 120 and the substrate 112. Accordingly, when the testing device is positioned over the covering anode 120, the spacers may space an end of the testing device at the predefined distance from the covering anode. Thus, the substrate simulator may be supported in the testing device in a position substantially aligned with or flush with the end of the testing device.

At block 610, the substrate simulator is electrically connected to an electron source, such as the electron source 124, and electrons are supplied to the testing system 100. In particular, the electron source 124 may be configured to supply electrons to the substrate simulator, simulating the conditions and the supply of electrons to the substrate 112 to be protected. Notably, since the substrate simulator is spaced away from the covering anode 120, no current will flow through the covering anode 120, since the circuit is not complete (i.e., the circuit is interrupted by the space between the covering anode 120 and the substrate simulator).

At block 615, an electrolyte is administered between the substrate simulator and the covering anode 120. For example, the electrolyte may be delivered via the testing device, and more particularly, through delivery channels in the testing device. For example, the electrolyte may be held in a reservoir such as the reservoir 144 and pumped via the actuator 148 to the delivery channel 136 of the testing device 104. In other examples, other manners of delivering the electrolyte via the testing device are also contemplated. For example, the electrolyte may be injected at the injection site 528 of the testing device 104, and driven by the plunger actuator 532 through the passageway 520 and into the delivery channels 524.

In particular, the electrolyte between the substrate simulator and the covering anode 120 completes the circuit and the electrochemical cell, allowing current to flow through the covering anode 120, the electrolyte and the substrate simulator before returning to the electron source 124. Accordingly, at block 620, a response may be detected indicating a flow of current between the covering anode and the substrate simulator via the electrolyte.

In particular, the response may include current measurements obtained by sensors embedded in the covering anode 120 during the performance of block 615. The response may be analyzed at block 625, for example by a computing device or server. If response detected at block 620 indicates a non-zero flow of current (i.e., the sensors obtain measurements indicating a non-zero flow of current through the covering anode 120), then it may be determined at block 630 that the corrosion protection system 108, and the detection capabilities of the sensors in the covering anode 120 are functional.

In some examples, in addition to checking for a non-zero flow of current, at block 635, the response detected at block 620 may be analyzed to determine whether the defect locationing capabilities of the sensors in the covering anode 120 are functional. That is, measurements from a first subset of sensors within a first predefined radius of the testing location (i.e., the location at which the substrate simulator is positioned over the covering anode 120), and from a second subset of sensors outside the first predefined radius, and within a second predefined radius of the testing location, may be obtained. The measurements may be compared to verify that the measurements from the first subset of sensors indicate a greater signal strength than the measurements from the second subset of sensors.

In other examples, a more precise testing of the locationing capabilities may be performed. For example, measurements may be obtained from the sensors embedded in the covering anode, and the measurements analyzed to identify a predicted location, according to a standard locationing process of the corrosion protection system 108. If the predicted location matches the location on the covering anode 120 at which the testing was performed, the locationing capabilities of the corrosion protection system 108 may be determined to be functional.

If, at block 625, the response detected at block 620 indicates a zero flow of current, it may be determined at block 640 that some portion of the corrosion protection system 108 is non-functional, allowing an operator to proceed with further troubleshooting.

Thus, as described above, the present devices, systems and methods allow for non-destructive testing of a corrosion protection system, and in particular, defect detection and defect locationing capabilities of the corrosion protection system. Advantageously, the non-destructive nature of the presently described devices systems and methods allows the corrosion protection systems to be better maintained and extends their lifetime, while still ensuring their viability.

The scope of the claims should not be limited by the embodiments set forth in the above examples but should be given the broadest interpretation consistent with the description as a whole.

1. A testing device for a corrosion protection system including a covering anode electrically insulated from a substrate to be protected, the testing device comprising:
a housing having an end configured to be positioned over a portion of the covering anode of the corrosion protection system;
a substrate simulator configured to simulate the substrate to be protected, the substrate simulator supported in the housing proximate the end; and
at least one delivery channel configured to deliver an electrolyte to the end between the substrate simulator and the covering anode to test detection of a current flowing through the corrosion protection system to the substrate simulator via the electrolyte.

2. The testing device of claim 1, further comprising a support body configured to support the substrate simulator in the housing at a predefined distance from the end of the housing.

3. The testing device of claim 2, wherein the at least one delivery channel extends through the support body.

4. The testing device of claim 2, wherein the support body further comprises a mechanism configured to extend the substrate simulator from the support body and retract the substrate simulator into the support body.

5. The testing device of claim 1, further comprising at least one spacer at the end of the housing, the at least one spacer configured to space the end of the housing from the covering anode.

6. The testing device of claim 5, wherein a thickness of the at least one spacer is equal to a distance between the covering anode and the substrate to be protected.

7. The testing device of claim 1, further comprising a contact region comprising a deformable material to conform to the covering anode.

8. The testing device of claim 7, wherein the contact region extends around a perimeter of the end of the housing to maintain the electrolyte between the substrate simulator and the covering anode.

9. The testing device of claim 1, further comprising at least one relief channel configured to receive backflow of an excess of the electrolyte.

10. The testing device of claim 1, further comprising a clamp configured to secure the testing device to the covering anode of the corrosion protection system.

11. The testing device of claim 10, wherein the clamp comprises:
two segments configured to be placed around the housing of the testing device and secured together; and
two respective slots, each slot extending through one of the two segments, the two respective slots configured to receive a belt to be secured around a substantially tubular substrate.

12. The testing device of claim 10, wherein the clamp comprises:
two segments configured to be placed around the housing of the testing device and secured together; and
two respective suction cups, each suction cup extending from one of the two segments, the two respective suction cups configured to be applied to a substantially flat substrate.

13. A testing system comprising:
the testing device of claim 1; and
a reservoir configured to contain the electrolyte; and
an actuator in fluid communication with the reservoir and the at least one delivery channel, the actuator configured to drive the electrolyte from the reservoir to the at least one delivery channel.

14. A method in a testing system to test a corrosion protection system, the method comprising:
placing a substrate simulator proximate to and spaced apart from a covering anode of the corrosion protection system, the substrate simulator configured to simulate a substrate to be protected by the corrosion protection system;
providing electrons to the testing system;
administering an electrolyte between the substrate simulator and the covering anode; and
detecting a response indicating a flow of the current between the substrate simulator and the covering anode via the electrolyte.

15. The method of claim 14, wherein placing the substrate simulator comprises positioning a testing device including the substrate simulator over the covering anode.

16. The method of claim 14, wherein the substrate simulator is spaced apart from the covering anode by a predefined distance.

17. The method of claim 14, wherein the response comprises current measurements obtained by sensors embedded in the covering anode.

18. The method of claim 14, wherein: when the response indicates a non-zero flow of current, determining that a defect detection capability of the corrosion protection system is functional.

19. The method of claim 18, further comprising analyzing the response to verify that a defect locationing capability of the corrosion protection system is functional.

20. The method of claim 14, wherein: when the response indicates a zero flow of current, determining that the corrosion protection system is non-functional.
